(19) United States
(12) Patent Application Publication
(10) Pub. No.: US 2017/0331772 A1
(43) Pub. Date: Nov. 16, 2017

(54) Chat Log Analyzer

(71) Applicant: Clutch Group, LLC, Washington, DC (US)

(72) Inventor: Kenneth Joseph STILLABOWER, Glenn Dale, MD (US)

(73) Assignee: Clutch Group, LLC, Washington, DC (US)

(21) Appl. No.: 15/522,157

(22) PCT Filed: Oct. 27, 2014
(86) PCT No.: PCT/US14/62429

§ 371 Date: Apr. 26, 2017

(51) Int. Cl. H04L 12/58; H04L 29/06; H04L 29/08; H04L 12/18

(52) U.S. Cl. CPC H04L 51/12; H04L 51/04; H04L 29/06; H04L 12/1813; H04L 67/22

(57) ABSTRACT

A method of analyzing and organizing chat and instant message log files begins by receiving chat session log data files (200). The method continues by scanning and marking (206A) the chat session log data files to maintain existing relationships such as attachments. The method continues by re-ordering segments (206B) of the chat session log data files according to provided objectives such as category. The method continues by loading message data into a message organizer and writing to a readable format for output (214). The method continues by re-scanning for desired metadata and outputting a load file with any metadata discovered (216/504/509). The output readable format, including the required metadata, can be analyzed (218) for one or more of: litigation, compliance or legally-defensible review applications.

### STATEMENT REGARDING FEDERALLY SPONSORED RESEARCH OR DEVELOPMENT

NOT APPLICABLE

### CROSS REFERENCE TO RELATED PATENTS

NOT APPLICABLE

### INCORPORATION-BY-REFERENCE OF MATERIAL SUBMITTED ON A COMPACT DISC

NOT APPLICABLE

### BACKGROUND OF THE INVENTION

### Technical Field of the Invention

The present disclosure relates to a method and system for interpreting chat logs. More specifically, it is related to interpreting chat logs from a computer network for litigation, compliance and other legally-defensible review applications.

### Description of Related Art

Computers are known to communicate, process, and store data. Such computers range from wireless smart phones to data centers that support millions of web searches, stock trades, or on-line purchases every day. In general, a computing system generates data and/or manipulates data from one form into another. Communications between computing systems, for example a chat session, are logged (recorded) for various future uses. The term chat room, or chatroom, is primarily used to describe any form of synchronous conferencing, occasionally even asynchronous conferencing. The term can thus mean any technology ranging from real-time online chat and online interaction with strangers over instant messaging and online forums to fully immersive graphical social environments.

The primary use of a chat room is to share information via text with a group of other users. Generally speaking, the ability to converse with multiple people in the same conversation differentiates chat rooms from instant messaging programs, which are more typically designed for one-to-one communication. The users in a particular chat room are generally connected via a shared interest or other similar connection, and chat rooms exist catering for a wide range of subjects. New technology has enabled the use of file sharing and webcams to be included in some programs.

Logging systems primarily output one of two formats, either an XML delimited format for storing of objects or a text file using comma or other characters to delimit the fields with, for example, one line per message. These systems require some form of reformatting. Current systems provide some formatting based on the original source file. However, XML logs are often fragmented into short fragments of an hour or less or the text files are interspersed with other messages happening in various chat rooms at different times.

Parsing is a syntactic analysis of analyzing a string of symbols, either in natural language or in computer languages, according to the rules of a formal grammar. Typical log parsing systems are focused on providing a faithful representation of the original activity based on the provided log. For litigation and compliance, this requires providing the relevant information in a cleaner format with the relevant chat messages and participants from the file. The current art of chat log processing systems are designed to provide an efficient summary of various chat activity but not a complete log for use in litigation or other legal contexts.

There are multitudes of logging techniques that are often difficult to understand and review. Logs are designed for efficient storage and retrieval of individual messages but not for review in a manner similar to their initial chat display. Further these logs are not designed to be loaded into e-discovery application for review by attorneys. The logs require costly searching or re-construction to determine chat participation and provide proof of knowledge or lack of knowledge.

### BRIEF DESCRIPTION OF THE SEVERAL VIEWS OF THE DRAWING(S)

FIG. 1 is a schematic block diagram of an embodiment of a computing system architecture of a chat log analyzing system in accordance with the present disclosure;

FIG. 2 is a flowchart illustrating chat log processing in accordance with the present disclosure;

FIG. 3 is another flowchart illustrating chat log processing in accordance with the present disclosure;

FIG. 4 is yet another flowchart illustrating chat log processing in accordance with the present disclosure; and

FIG. 5 is yet another flowchart illustrating chat log processing in accordance with the present disclosure.

### DETAILED DESCRIPTION OF THE INVENTION

### Summary of the Invention

One or more embodiments of the present disclosure organize a chat session by relevant categories in a logical fashion. In addition, the organization of chat data may be by divided into approximately equal chunks (sizes) to be efficiently reviewed or analyzed in a legal context. Also, the present disclosure facilitates appropriate data analytics to be applied to files (documents) for analysis as their original format provides a significant amount of analytically un-useful information that the system picks up on as similar data.

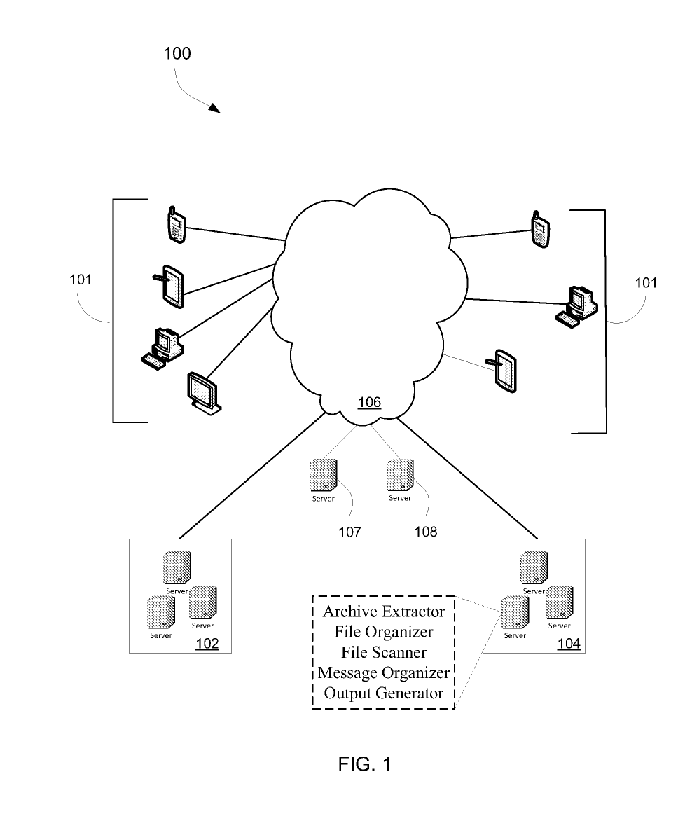

The above mentioned embodiments include a communication management platform for chat logs provided in a computer network including an archive extractor, file organizer, file scanner, message organizer, and output generator. Referring now to FIG. 1, there is shown system architecture of a chat log analyzing system 100. Chat log analyzing system 100, in one embodiment, includes computer-based devices 101 generating logs during chat sessions, remote chat session storage 102 and chat log processing system 104. Computer-based devices 101, remote chat session storage 102 and chat log processing system 104 are coupled via a network channel 106. Network channel 106 is a system for communication. Network channel 106 in various embodiments encompasses one or more of a variety of mediums of communication, such as via wired communication for one part and via wireless communication for another part. Network channel 106, in one embodiment, is implemented as part of the Internet and includes systems, processing, and/or storage on, for example, cloud based servers.

For example, network channel 106 includes an Ethernet or other wire-based network or a wireless NIC (WNIC) or wireless adapter for communicating with a wireless network, such as a WI-FI network. Network channel 106 includes any suitable network for any suitable communication interface. As an example and not by way of limitation, network channel 106 includes an ad hoc network, a personal area network (PAN), a local area network (LAN), a wide area network (WAN), a metropolitan area network (MAN), or one or more portions of the Internet or a combination of two or more of these. One or more portions of one or more of these networks are wired and/or wireless. As another example, the network channel 106 is a wireless PAN (WPAN) (such as, for example, a BLUETOOTH WPAN), a WI-FI network, a WI-MAX network, a 3G or 4G network, a cellular telephone network (such as, for example, a Global System for Mobile Communications (GSM) network).

In one embodiment, network channel 106 uses standard communications technologies and/or protocols. Thus, network channel 106 includes links using technologies such as Ethernet, 802.11, worldwide interoperability for microwave access (WiMAX), 3G, 4G, CDMA, digital subscriber line (DSL) or equivalents. Similarly, the networking protocols used on network channel 106, uses for example one or more of: multiprotocol label switching (MPLS), the transmission control protocol/Internet protocol (TCP/IP), the User Datagram Protocol (UDP), the hypertext transport protocol (HTTP), the simple mail transfer protocol (SMTP), and the file transfer protocol (FTP). The data exchanged over network channel 106 can be represented using technologies and/or formats including the hypertext markup language (HTML) and the extensible markup language (XML). In addition, all or some of links can be encrypted using conventional encryption technologies such as secure sockets layer (SSL), transport layer security (TLS), and Internet Protocol security (IPsec).

In one embodiment, remote chat session storage 102 collects chat session data (logs) created/uploaded from remotely connected devices, for example, computer-based devices 101. Computer-based devices 101 are defined as electronic devices for communicating with one or more other computer-based devices 101 to produce at least chat sessions. For example, computer-based devices 101 include, for example, a smart phone, a tablet, personal computer (PC), television w/internet connection, a laptop, a pair of electronic glasses, watch, wearable computer, equivalents or any combination thereof. Computer-based devices 101 can directly upload chat session log data to the remote chat session storage 102 via network channel 106, network storage 107 or can indirectly upload chat session data through third party servers 108. For example, the chat session data can be transferred from a computer-based device first to a networked computer 107 and then transferred to remote chat session storage 102. For another example, chat sessions can be recorded (logged) on third party server 108 (e.g., chat room host) first before being uploaded to remote chat session storage 102. Chat sessions recorded at networked servers 107 or third party servers 108 may receive additional processing such as reorganization, filtering, encoding, compression, review, deletion, archiving, etc. before transference to remote chat session storage 102 or to chat log processing system 104.

In one embodiment, chat log processing system 104 processes the remote chat session data collected. The chat log processing system 104, according to one or more embodiments of the technology described herein, can include one or more servers with one or more modules with computer processors, supporting circuitry and memory (non-transitory and transitory), which serve as an archive extractor, file organizer, file scanner, message organizer and output generator. The various servers and modules may include hardware, software, firmware or other coded computer functionality to implement the various components and methods of the technology as described herein.

The archive extractor portion is used for extracting chat session log data from zip archives, PST archives and MSG files including any MSG attachments. The chat session log data can be stored locally (memory associated with servers 104); within remote chat session storage 102; within networked computer 107 storage; third party server 108 storage and/or computer-based device storage 101. The archive extractor portion passes these files to the file organizer to be read and then marked appropriately for organization to maintain existing relationships, e.g., keeping message attachments with messages.

After marking, an organizer function can re-order the file segments according to provided objectives such as time or chat room. This is accomplished utilizing a number of means (e.g., file system sorting using file naming conventions, a structured datastore, internal memory tables, etc.). One embodiment of a structured datastore for the message organizer includes a relational database management system, such as SQL Server, Oracle or MySQL. Upon completion of message organizing, the messages are written to an easily readable format (e.g., even size chunks, original chat format, modified chat format, selected text format, simplified format, reduced size, etc.) for output. Finally, the generated output is re-scanned by the file scanner for any desired metadata and an output of any required metadata is generated by the output generator.

While shown as part of a single server, the functionality of the archive extractor, file organizer, file scanner, message organizer, and output generator may be provided by one or more servers, locally organized or distributed and made up of one or more modules including one or more processors and computer memory (transitory and non-transitory) with computer code and data stored therein.

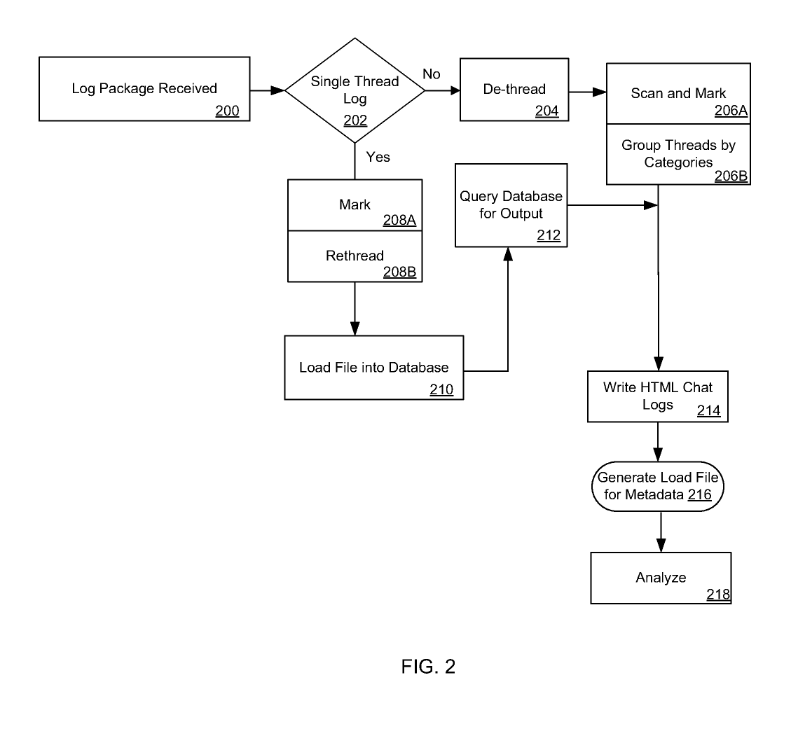

FIG. 2 is a flowchart illustrating chat log processing in accordance with the present disclosure. As shown, the flowchart illustrates an overview of chat log processing as performed by one or more processing modules (e.g., archive extractor) of chat log processing system 104. The method begins with step 200 where a processing module of chat log processing system 104 receives a log package from local storage, remote chat session storage 102, networked computer 107, third party server 108 and/or computer-based devices 101. The log package may include one or more of a single chat session log, a plurality of related log sessions (e.g., by time, chat room, company, content, participants, email addresses, location, keywords, etc.) or a bulk download of stored chat session data (e.g., by time, chat room, company, content, participants, email addresses, location, keywords, etc.).

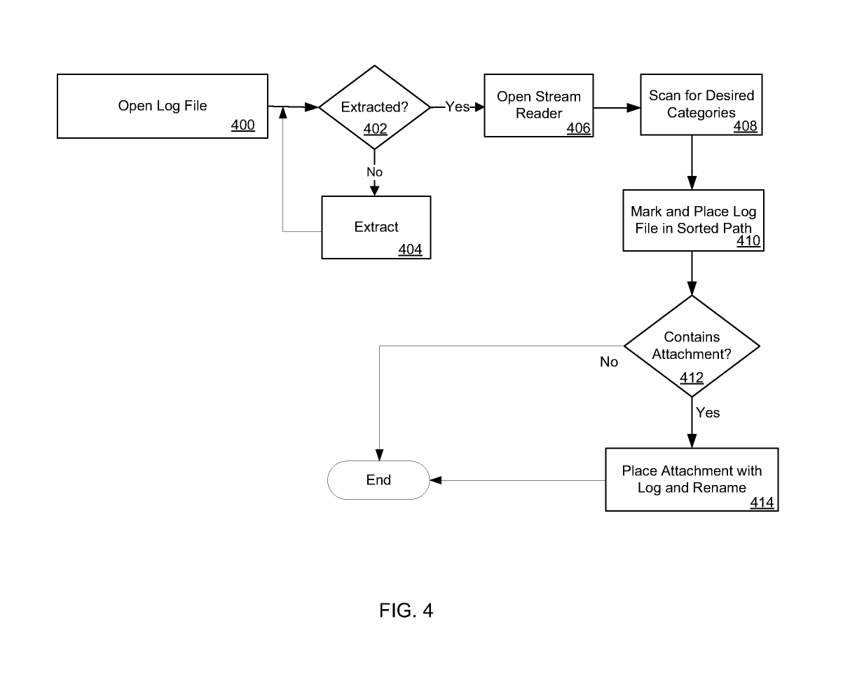

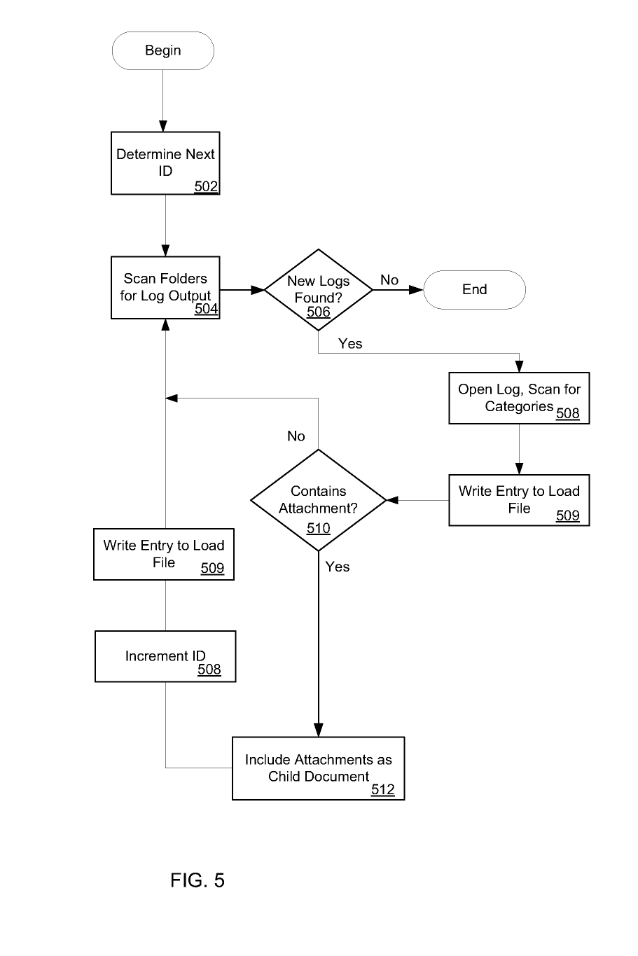

The method continues at step 202 where a processing module determines if the log package is limited to one or more chat threads (sequences of common inputs to specific chat session). When the log package includes a plurality of logs (e.g., common users in a single room and adjacent time span across multiple logs), the method continues at step 204 where the processing module de-threads (separates into common threads). The method continues in step 206A where the files are scanned for desired categories (e.g., subject, attendees, company, time frame, etc.) and further marked with high level metadata for output as further described in association with FIG. 4. In step 206B, once scanned and marked, the files are grouped into the desired categories determined in the scan. In step 214, the chat logs are written in hypertext markup language (HTML) or similar rich text format. HTML is a standardized system for tagging text files to achieve font, color, graphic, and hyperlink effects on World Wide Web pages and, in step 216, prepared as a load file for metadata annotation as further described in association with FIG. 5.

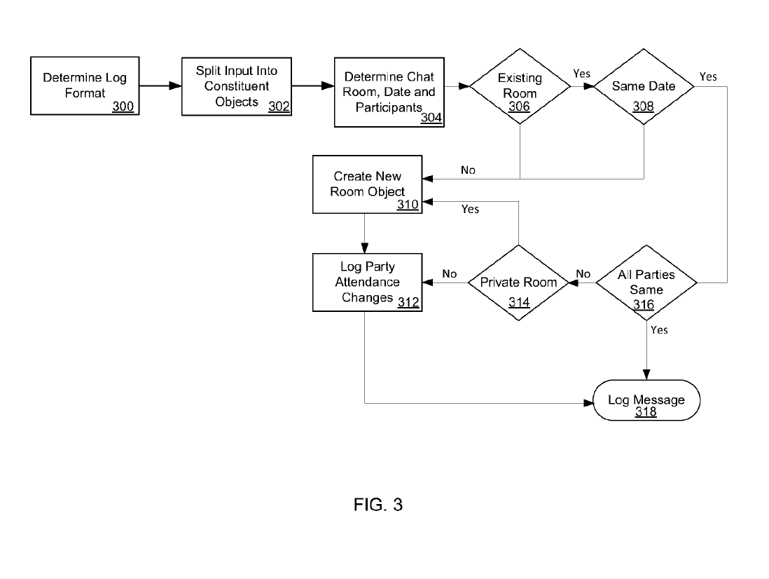

When the log package contains only a single thread, the method continues at step 208A where the processing module marks the messages based on desired metadata (message time, participants, location, etc.) and then, in step 208B, rethreads the chat logs (e.g., creates groupings of similar messages based on the same chat room, date, participants, etc.). In step 210, the rethreaded marked chat log file is loaded into a structured datastore as described further in association with FIG. 3. The method continues by looping through existing chat thread objects and then queries, in step 212, each constituent object for associated messages. The method continues with step 214 where the chat logs are written in hypertext markup language (HTML) format and, in step 216, prepared as a load file for metadata annotation (FIG. 5).

In step 218, the organized annotated files can be analyzed for one or more of: litigation, compliance or legally-defensible review applications. However, other types of structured and unstructured analysis can be performed without departing from the scope of the technology described herein.

FIG. 3 is another flowchart illustrating chat log processing in accordance with the present disclosure. As shown, a processing module of chat log processing system 104 performs the message organizer function loading of the chat log files into a database (FIG. 2, step 210). The process begins with step 300, where the log format is determined (example log formats include Excel sheets, comma separated values (csv), tab delimited or other miscellaneous character delimited formats). The method continues at step 302 where the processing module splits the input into constituent objects (e.g. chat sender, recipients, room name, date, message text, etc.) and, in step 304, further determines one or more of the specific chat room features to sort by (e.g., date, time, time span (e.g., from 2-4 on Tuesday) and or participants).

The method continues in step 306 where a chat room determination is made. For existing chat rooms, in step 306, a corresponding date (308) and parties (316) determination is made. If all parties are the same, a log message is created. However, if all parties are not the same, in step 314, a check is performed to determine if the room is private (has a common name, but many unique instances). If the room is private, a new instance of the room is created with a unique identifier. If the chat room identified does not previously exist, in step 310, a new chat room object is created and marked within the desired organizing system. In step 312, the outputs from steps 310 and 314 are used to log party attendance changes (e.g., joining or leaving) and the log message is subsequently created in step 318 and marked into the datastore for output at the completion of message organization. This includes, for example, the room object information, time and message text.

FIG. 4 is yet another flowchart illustrating chat log processing in accordance with the present disclosure. As shown, a processing module of chat log processing system 104 performs FIG. 2, steps 206A and 206B, by scanning, extracting, marking and grouping chat log files to similar sized data streams. The method begins with step 400, where a log file is opened. If the log file has not yet been extracted (e.g., unzipped), in step 404 it is extracted from any file containers (i.e., ZIP, TAR, PST, MSG, etc.) and passed in step 406 to an open file streamreader (i.e., C#'s StreamReader, Java's InputStream, C++'s BufferedReader or similar programmatic file input handler) where a stream of data is formed and stream access rules defined.

The method continues in step 408, where the log file is scanned for desired categories (e.g., business, personal, project, subject, time frame) and, in step 410, marked and placed in a sorted processing path (grouped). In step 412, a determination is made of whether the file contains an attachment. If the file does not contain an attachment, the scan process ends. If the log file contains an attachment, in step 414, the attachment is placed with the log file (to maintain marking) and renamed.

FIG. 5 is yet another flowchart illustrating the generation of a load file of processed chats in accordance with the present disclosure. Metadata files are required to enable categorization and efficient searching of metadata of the parsed chat logs. As shown, a processing module of chat log processing system 104 includes at least FIG. 2, step 216, by generating a load file for metadata. The method to generate begins with step 502, where an ID is determined representing the last generated ID for the system ingesting the metadata load file. In step 504, the folders of the metadata load files are scanned for log output. If no new logs are found, then in step 506, the process ends. While new logs are found, in step 508, the log found is opened, scanned for categories and written to load file (509). The method continues in step 510, to determine if an attachment to the log file exists. If an attachment exists, it is included as a child file (document) in step 512. The ID is incremented and as previously described in step 509, is written to the load file. The process is repeated until no additional new log files are found.

One or more benefits of the present disclosure include, but are not limited to, providing a clear and concise record of the presence of individual chatters for use in litigation as alibi or incriminating evidence as proof that someone was present or absent for particular messages.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “operably coupled to”, “coupled to”, and/or “coupling” includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item. As may be used herein, the term “compares favorably”, indicates that a comparison between two or more items, signals, etc., provides a desired relationship.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention. For example, grouping, messaging and marking steps may be considered parallel operations, or in some embodiments, performed in a different order.

The present invention has been described, at least in part, in terms of one or more embodiments. An embodiment of the present invention is used herein to illustrate the present invention, an aspect thereof, a feature thereof, a concept thereof, and/or an example thereof. A physical embodiment of an apparatus, an article of manufacture, a machine, and/or of a process that embodies the present invention may include one or more of the aspects, features, concepts, examples, etc. described with reference to one or more of the embodiments discussed herein.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

What is claimed is:

1. A method of analyzing chat logs comprises:
receiving chat session log data files (200);
marking the chat session log data files to maintain existing relationships (206A);
re-ordering segments of the chat session log data files according to provided objectives (206B);
organizing and writing to a readable format for output (214);
re-scanning for desired metadata (216/504); and
outputting a load file with any of the desired metadata discovered (216).

2. The method of claim 1, wherein the chat session log data can be stored in any of:
local computer storage (104); chat session server storage (102); networked computer storage (107); third party server storage (108); or computer-based device storage (101).

3. The method of claim 1, wherein the receiving chat session log data files is based on extracting (402) chat session log data files from larger files.

4. The method of claim 3, wherein the larger files include any of: zip archives; PST archives; and MSG files including any MSG attachments.

5. The method of claim 1, wherein the maintaining existing relationships includes keeping message attachments with messages (414).

6. The method of claim 1, wherein the provided objectives include organizing based on category (408).

7. The method of claim 1, wherein the categories include one or more of: time, chat room, company, content, participants, email addresses, location or keywords.

8. The method of claim 1, wherein the output load file is analyzed (218) for one or more of: litigation, compliance or legally-defensible review applications.

9. A chat log analyzing system configured to:
receive chat session log data files (200);
mark the chat session log data files to maintain existing relationships (206A);
re-order segments of the chat session log data files according to provided objectives (206B);
organize and write to a readable format for output (214);
re-scan for desired metadata (216/504); and
outputting a load file with any of the desired metadata discovered (216).

10. The system of claim 9, wherein the output load file is analyzed (218) for one or more of: litigation, compliance or legally-defensible review applications.

11. A chat log processing system comprising:
an archive extractor for receiving and extracting chat session log data (104/402);
a file organizer to mark files within the chat session log data appropriately to maintain existing relationships (104/206A);
a file scanner to re-order file segments of the marked files according to provided objectives and additionally scan for any required metadata (104/206B);
a message organizer providing a readable format for output (104/214); and
an output generator to output the readable format and any of the required metadata discovered during scanning (104/216).

12. The chat log processing system of claim 11, wherein the message organizer divides the readable format into approximately equal chunks (sizes).

13. The chat log processing system of claim 11, wherein the readable format includes a format efficiently reviewed or analyzed (218) in a legal context.

14. The chat log processing system of claim 11, wherein the message organizer includes a relational database management system (210).

15. The chat log processing system of claim 11, wherein the readable format comprises an original chat data format which facilitates data analytics for analysis including similar data.

16. The chat log processing system of claim 11, wherein the archive extractor includes extracting (402) chat session log data from zip archives, PST archives and MSG files including any MSG attachments.

17. The chat log processing system of claim 11, wherein the marked appropriately to maintain existing relationships includes keeping message attachments (414) with messages.

18. The chat log processing system of claim 11, wherein the readable format includes any of: even sized chunks, original chat format, modified chat format, selected text format, simplified format or reduced size.

19. The chat log processing system of claim 11, wherein the objectives include any of:
company, content, participants, email addresses, location or keywords.

20. The chat log processing system of claim 11, wherein the output readable format, including the required metadata, is analyzed (218) for one or more of: litigation, compliance or legally-defensible review applicati
